(19) United States
(12) Patent Application Publication
(10) Pub. No.: US 2003/0093289 A1
(43) Pub. Date: May 15, 2003

(54) Reporting and collecting rent payment history

(76) Inventors: Robert D. Thornley, Greenwood Village, CO (US); Andrew Lermsider, Greenwood Village, CO (US); Michael A. Britti, Greenwood Village, CO (US)

Correspondence Address: MERCHANT & GOULD PC, P.O. BOX 2903, MINNEAPOLIS, MN, 55402-0903, US

(21) Appl. No.: 10/209,094

(22) Filed: Jul. 30, 2002

Related U.S. Application Data
(60) Provisional application No. 60/308,975, filed on Jul. 31, 2001.

(51) Int. Cl. G06F 17/60

(52) U.S. Cl. 705/1

(57) ABSTRACT

A rent payment history system collects data associated with rent payments for a plurality of renters, leases, and lease events. Property managers report out lease events to a central repository in a systematic manner. The content of the data is also systematically defined to accommodate the unique aspects of leasing arrangements (e.g., late payments, pet fees, deposits, damage penalties, skips, etc.). The data is stored in the central repository for access by a plurality of property managers, to assist in a large variety of leasing and credit decisions. Credit bureaus and other entities may access the lease history data to make credit determinations and marketing decisions.

### CROSS REFERENCE TO RELATED APPLICATIONS

This application claims benefit of U.S. Provisional Application No. 60/308,975, filed Jul. 31, 2001 and entitled METHOD OF REPORTING RENT PAYMENT HISTORY, specifically incorporated herein by reference for all that it discloses and teaches.

### BACKGROUND OF THE INVENTION

Currently, more than 35% of the United States population lives in apartments, rental housing, mobile homes, or other housing not entirely owned by the occupant. In many other countries, this percentage is much higher. There are more than 35 million rental properties in the U.S., and monthly residential lease payments are the second largest category of consumer payments behind mortgage payments. However, comprehensive consumer credit data and central data collecting and reporting services do not exist for payments of leases of residential housing and many other lease arrangements, even though it exists for mortgage payments and major revolving consumer payments.

Similarly, there is presently no consistent standard for residential lease reporting at national and international credit bureaus. In particular, there are no credit reporting standards in the multifamily residential property rental industry. Historical lease payment information is not compiled to any central data warehouse for use by multiple, otherwise unrelated leasing organizations. Therefore, the existing tenant evaluation and approval process is manually intensive, time-consuming, and of limited value because of the sparseness and unreliability of available information. In current approaches, to check a prospective tenant's lease payment history, landlords and other leasing organizations call previous landlords to inquire about the prospective tenant. Some landlords even require a prospective tenant to present cancelled rent payment checks.

One cause of the non-systematic approach of previous methods is that thousands of landlords are needed to report tenant behavior, where many groups of landlords use different property management software or none at all. These landlords are largely independent, and even when some relationship exists among certain landlords, wholesale swapping of tenant information between two landlords is costly and inefficient. Accordingly, an evicted tenant can often go across the street to another apartment complex and rent another apartment with impunity—the new landlord does not have adequate information about the tenant's previous lease.

Accordingly, there exists no adequate system for reporting and collecting information regarding rent payment histories of consumers. Furthermore, the collection and reporting that does exist (e.g., manual phone investigations to previous landlords) tends to include vague and inconsistent information only about the lessee's status at the termination of the lease, and fails to include information about good and bad payment history during the lease itself. Such currently available information is inconsistently applied by landlords, is stored in inconsistent formats, and is difficult to share among different landlords.

Furthermore, existing approaches fail to systematically report and collect lease history data on residential or commercial properties. Existing approaches also fail to systematically provide any such lease history data to other credit reporting entities in such a form that it may be integrated easily with other credit-related data (e.g., from revolving credit performance and mortgages).

### SUMMARY OF THE INVENTION

The problems described above and others are solved by a rent payment history system that collects data associated with rent payments for a plurality of renters, leases, and lease events. Property managers report out lease events to a central repository in a systematic manner. The content of the data is also systematically defined to accommodate the unique aspects of leasing arrangements (e.g., late payments, pet fees, deposits, damage penalties, skips, etc.). The data is stored in the central repository for access by a plurality of property managers, to assist in a large variety of leasing and credit decisions. For example, a landlord can access the central repository for past rent payment data relating to a prospective tenant. For a tenant whose records show an excellent rental record, the landlord may be more liberal in the terms of the lease. In contrast, if the tenant's records indicate rental problems, such as skips (i.e., moving out of the property owing money to the property manager or a utility prior to or at expiration of the lease), late payments, property or pet damage, etc., the landlord can be more conservative in the proposed terms of the lease, including requiring a larger deposit, a shorter term lease with higher rent, or a larger pet fee. Such data can also be applied to commercial rental properties, by association with company names or other identifiers or with identities of corporate officers or financers of commercial tenants.

In implementations of the present invention, articles of manufacture are provided as computer program products. One embodiment of a computer program product provides a computer program storage medium readable by a computer system and encoding a computer program that collects one or more lease histories. Another embodiment of a computer program product may be provided in a computer data signal embodied in a carrier wave by a computing system and encoding the computer program that collects one or more lease histories. Methods and systems for collecting one or more lease histories are also provided.

These and various other features as well as other advantages, which characterize the present invention, will be apparent from a reading of the following detailed description and a review of the associated drawings.

### BRIEF DESCRIPTION OF THE DRAWINGS

FIG. 1 illustrates a network including a payment history system in an embodiment of the present invention.

FIG. 2 illustrates a hierarchy of elements of consumer lease records in an embodiment of the present invention.

FIG. 3 illustrates an agreement history in an embodiment of the present invention.

FIG. 4 illustrates an options screenshot from a payment history system in an embodiment of the present invention.

FIG. 5 illustrates a first portion of a registration screenshot from a payment history system in an embodiment of the present invention.

FIG. 6 illustrates a second portion of an introductory registration screenshot from a payment history system in an embodiment of the present invention.

FIG. 7 illustrates a screenshot of a first stage in a tenant data input process from a payment history system in an embodiment of the present invention.

FIG. 8 illustrates a first portion of screenshot of a second stage in a tenant data input process from a payment history system in an embodiment of the present invention.

FIG. 9 illustrates a second portion of screenshot of a second stage in a tenant data input process from a payment history system in an embodiment of the present invention.

FIG. 10 illustrates a third portion of screenshot of a second stage in a tenant data input process from a payment history system in an embodiment of the present invention.

FIG. 11 illustrates a first portion of screenshot of a third stage in a tenant data input process from a payment history system in an embodiment of the present invention.

FIG. 12 illustrates a second portion of screenshot of a third stage in a tenant data input process from a payment history system in an embodiment of the present invention.

FIG. 13 illustrates a third portion of screenshot of a third stage in a tenant data input process from a payment history system in an embodiment of the present invention.

FIG. 14 illustrates a screenshot of a tenant search query form in an embodiment of the present invention.

FIG. 15 illustrates a screenshot of a tenant search results list from a payment history system in an embodiment of the present invention.

FIG. 16 illustrates a first portion of a screenshot of a tenant search result from a payment history system in an embodiment of the present invention.

FIG. 17 illustrates a second portion of screenshot of a tenant search result from a payment history system in an embodiment of the present invention.

FIG. 18 illustrates an exemplary system useful for implementing an embodiment of the present invention.

FIG. 19 illustrates operations for collecting one or more lease histories in an embodiment of the present invention.

### DETAILED DESCRIPTION OF THE PREFERRED EMBODIMENT

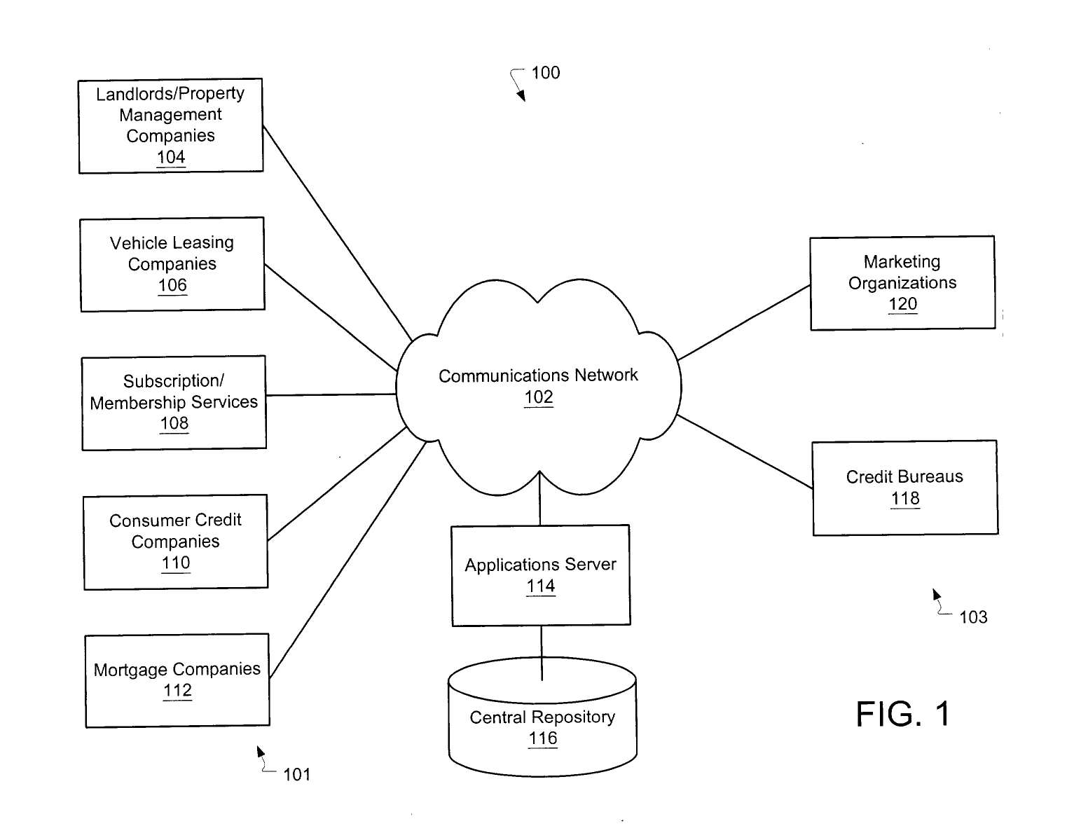

FIG. 1 illustrates a network 100 including a payment history system in an embodiment of the present invention. A lease payment history, for example, may relate to payments under a commercial real estate lease, an apartment lease, a residential housing lease, a mobile home pad lease, etc. A communications network 102 couples asset representatives 101 to an applications server 114, a central repository 116, and various data recipients 103. Exemplary asset representatives are shown as landlords/property management companies 104 (note: herein, both landlords and property managers are included under the definition of “property managers”), vehicle leasing companies 106, subscription/membership services 108, consumer credit organizations 110, and mortgage companies 112. Likewise, exemplary data recipients are shown as credit bureaus 118 and marketing organizations 120, although other data recipients are contemplated within the scope of the present invention. In addition, landlords and other asset representatives may also be data recipients, such as a prospective landlord evaluating the rental payment history of an applicant.

It should also be understood that the data reported and collected in an embodiment of the present invention relate generally to leases and are not limited to apartment leases. Therefore, leases for other property rights are also contemplated within the scope of the present invention, such as leases for mobile home space, rental housing, commercial real estate, time-share property, etc.

Generally, asset representatives for leasing companies process consumer applications (e.g., a lease application), receive payments (e.g., lease payments), manage lease exceptions (e.g., lease violations including late payments, property damage, maintenance, etc.), and process lease termination events (e.g., end-of-lease processing, skips, evictions, etc.) Such asset representatives may take many different forms and may include agents who perform the associated operations of the asset representatives. For example, property managers 104 manage leases with tenants, collect lease payments, and otherwise manage the property leased by the property manager 104. In some embodiments, a property manager may manage multiple properties, employing a significant, geographically dispersed staff to perform management tasks. Accordingly, property managers 104 may include various agents who can receive payments and input data to the central repository. Such properties may also include time-share-type of properties. Vehicle leasing companies 106 may manage a variety of leased vehicles (e.g., automobiles, boats, motorcycles, etc.) and receive lease payments therefore. Agents of the vehicle leasing companies 106 may perform the management tasks.

Generally, asset representatives for subscription/membership companies process subscription/membership applications (e.g., for health club memberships), receive payments (e.g., membership dues), manage membership exceptions (e.g., late payments, property damage, etc.), and process membership termination events (e.g., end-of-membership processing, skips, unilateral terminations, etc.) Such asset representatives may take many different forms and may include agents who perform the associated operations of the asset representatives.

Generally, asset representatives for consumer credit companies 110 process credit applications (e.g., a credit card application), receive payments (e.g., credit card payments), manage exceptions (e.g., late payments, disputes, etc.), and process credit card termination events (e.g., credit card account closing events, etc.). Such asset representatives may take many different forms and may include agents who perform the associated operations of the asset representatives.

Generally, asset representatives for mortgage companies 112 process mortgage applications, receive payments (e.g., credit card payments), manage exceptions (e.g., late payments, property tax payments, insurance changes, disputes, etc.), and process mortgage termination events (e.g., mortgage account closing events, etc.) Such asset representatives may take many different forms and may include agents who perform the associated operations of the asset representatives.

Each of the asset representatives reports consumer data (e.g., regarding a lessee) via a communications network such as the Internet, an intranet, a dial-up connection, a facsimile connection, and other known communications networks. Exemplary consumer data may include lease information, payment information, termination information, demographic data, and other information relating to the leased property and/or the lessee. The applications server 1 14 receives the reported consumer data and stores it into the central repository 116. It should be understood that the central repository 116 represents a logically “central” repository in which data is compiled and organized. However, it should be understood that physically, the central repository may be distributed into multiple storage units and may also be geographically distributed across multiple storage sites, coupled by a communications network.

In one embodiment, the data is communicated electronically from an asset management application used by the asset representative. For example, some property managers 104 employ property management software for initiating a lease, tracking payments and lease violations, and closing a leasing arrangement. Such software typically supports exporting of data or external retrieval of information by a third party. As such, the asset representative can export the consumer data to the applications server or the applications server can access the asset representatives system to retrieve the consumer data.

In another embodiment, consumer data may be entered manually by the asset representative or by the data collecting entity that runs the application server 114. In one manual embodiment, the asset representative 101 inputs the consumer data into another application that formats and transmits the data to the central repository 116 via the communications network 102. The application may be resident on the asset representative's desktop or handheld computer, or may be provided via the communications network 102, such as in the form of a Java applet or HTML form. Such applications provide a template for manual entry that facilitates data entry by the property manager. In another manual embodiment, ad hoc data may be submitted by the asset representative in a variety of forms and communications means (such as email, fax, telephone, etc.) to the data collecting entity, which enters the data into the central repository 116.

The applications server 114 includes one or more applications for processing the received or stored consumer data. One function of the applications server 114 in an embodiment of the present invention is to authenticate data ostensibly received from an asset representative. Access to the application server 114 or to the central repository 116 is secured using known security techniques, such as password protection. In this manner, unauthorized additions to the consumer data of a given consumer can be prevented. In one embodiment, for example, a landlord can only input data about a tenant during the term of the lease, plus or minus some time to allow processing of the lease application and the termination event.

In another embodiment, a function of the applications server 114 is to process consumer data in the central repository. Such processing may include analyzing trend data in a consumer's payment sequence to identify a probably skip or missed payment, analyzing past rental behavior to recommend a deposit amount, identifying inconsistencies in consumer applications (e.g., flagging past pet damage on an application that indicates no pets), and tracking the location of tenants who have skipped out of a lease with one property manager (e.g., detecting a lease application by the tenant through another property manager and notifying the first property manager of the tenant's location).

Another function of the applications server 114 is providing the consumer data to data recipients 103, such as the credit bureaus 118 and marketing organizations 120. The credit bureaus 118 can use the consumer data to supplement, or in some cases, initially generate, credit ratings for consumers. Many renters have not adequately developed a credit rating because of a lack of mortgage payment or credit card experience. It should also be understood that the consumer data can include both positive and negative data; therefore, it is desirable to many consumers to have their positive behavior of their patent rental experiences, for example, to be included in their credit rating computation.

In one embodiment, the system collects lease data from a plurality of property managers, potentially in many different kinds of formats, data contents, and reporting frequencies, and provides the data in a standardized format to data recipients. In this systematic approach, data recipients, such as credit bureaus, can easily integrate the collected data with other credit-related information. For example, mortgage data is typically reported in accordance with a data format called “METRO2”, which can be easily utilized by credit bureaus to prepare credit reports and compute credit ratings. Likewise, in an embodiment of the present invention, data recipients can access data from the central repository in a standardized format to contribute to credit reports and compute credit ratings.

Some marketing organizations 120 may also benefit from access to such consumer data. For example, real estate companies may be able to target individuals whose lease is nearing its termination or retailers may be able to offer incentives for new tenants in an apartment complex to shop with them. Such information may be provided with or without identification data and other sensitive information. For example, a marketing organization 120 may be provided with apartment number and address only, which can allow direct mailing to the retailer's target group but protect the tenant from telemarketing calls or from release of their names or credit histories.

One exemplary function of the applications sever 114 is to provide a current address check on a prospective tenant. For example, if an applicant lists a current non-rental address (e.g., “I'm living with my brother.”) on the landlord's lease application and the central repository shows that the applicant's actual current address is a rental unit for which late rent payments are owed, the new landlord may anticipate that the applicant is planning on skipping out of the current lease. As such, based on such likely behavior, the applicant presents a greater lease risk to the new landlord if the landlord agrees to rent the applicant one of his units. In addition, the applicant's deception, revealed by the data in the central repository 116, also calls into question, and possibly clarifies, other data on the application. In contrast, if the applicant provides a correct address and shows a positive lease history, then the new landlord may anticipate less risk in leasing a unit to the applicant.

Another exemplary function of an embodiment of the payment history system is to allow other asset representatives to access the central repository 116 to ascertain the payment history of a prospective customer (i.e., a new subscriber, member or tenant). It should be understood that an advantage of one embodiment of the present invention is that consumer data may be easily reported and collected during the agreement period (e.g., the lease period), not just at the beginning and end of a lease. In this manner, a richer history of the tenant's behavior can be reported and credit bureaus and other landlords can get a more accurate picture of the tenant's prior payment history (“a consumer payment record”) among other characteristics.

In one embodiment, a consumer's payment history is in the form of a “consumer lease record”, which can span multiple leases at one property or at different properties. A consumer lease record is intended to be the most complete record of the tenant's prior payment history possible, although gaps in reporting may still exist.

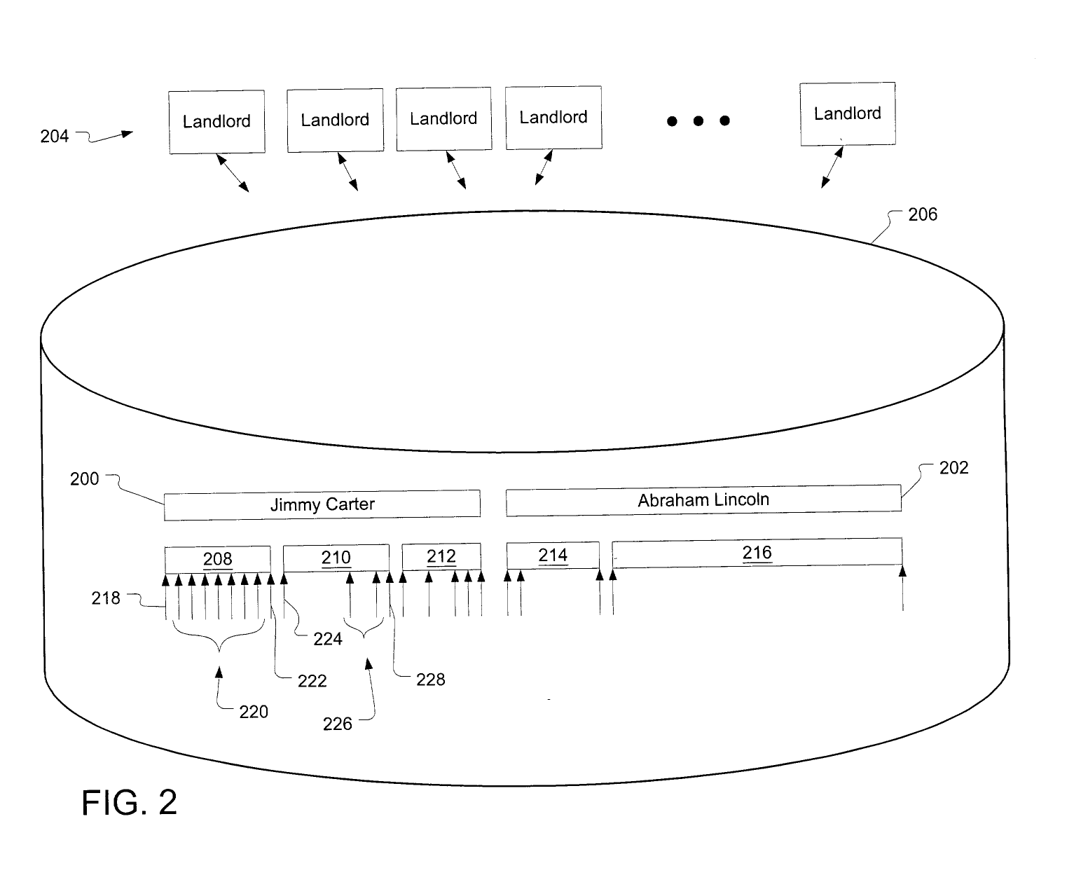

FIG. 2 illustrates a hierarchy of elements of consumer lease records in an embodiment of the present invention. A consumer lease record 200 for Jimmy Carter and a consumer lease record 202 for Abraham Lincoln have been reported by at least one of landlords 204 and stored in the central repository 206. It should be understood that either or both of the consumer lease records 200 and 202 could have been generated with data from multiple landlords, even if the multiple landlords are independent of each other (e.g., not affiliated or directly interacting in the reporting processing).

Each consumer lease record includes one or more lease histories, each of which may be with the same landlord or with different landlords. For example, Jimmy Carter has lived under three different leases 208, 210, and 212 that have been reported and collected to the central repository 206. Likewise, Abraham Lincoln has lived under two different leases 214 and 216 that have been reported and collected to the central repository 206.

Within each lease history, there typically exist multiple lease events, including a lease commencement event and a lease termination event. As such, in one embodiment, lease application data is input after the lease has been executed, and therefore will have at least two lease events. However, a lease history may also have only one lease event, such as when a lease is initially commenced and no other lease events have been reported. Alternatively, lease application data may be input prior to execution of the lease. In this way, information relating to whether or why a lease application was denied, a higher deposit was requested (but rejected by the applicant), etc. may be captured. Such pre-lease information can provide both positive and negative contribution to a lessee's lease record. For example, a tenant with a history of good payments is likely to have many approved application on his or her record, indicating heavy competition in the past for the tenant's business. As such, landlords may offer more attractive terms to this tenant than to a tenant with substantial application denials on his or her record.

It should be understood that a lessee, in an embodiment of the present invention, may include an entity or individual obligated (legally or financially) under a lease. That is, residents (a tenant's children) may be named on the lease and therefore may be bound to the terms of the lease (e.g., noise limits, parking restrictions, smoking restrictions, etc.). Likewise, co-signers may also be financially obligated under the lease. As such, the term “lessee” includes such residents, as well as co-signers, spouses and other family members, roommates, companies, organizations, etc.

A lease commencement event typically includes submission of a lease application, including information such as the applicant's name, current address, social security number, date of birth, income, etc., or renewal of a previous lease. As discussed, the lease commencement event may correspond to a time before or after execution of the lease (e.g., to submission a lease application or to the execution of the lease itself). In contrast, a lease termination event typically involves the usual end-of-lease closing activities (e.g., reconciliation of payments, such as return of deposit; return of the apartment keys; inspections; etc.), “skips” (wherein the tenant vacates the property before the end of the lease or without the typical end-of-lease closing activities), or eviction. Values that are important to lease termination events may include the cost of damage to the property done by the tenant, the amount of deposit returned, forwarding address to send the returned deposit, the outstanding payments, the circumstances resulting in net dollars due the property manager (e.g., damage, rent, utilities), etc. Particularly, utility payment obligations, although often not applied to the landlord, may nevertheless result in a lien against the property if the lessee does not maintain up-to-date payment of utility services.

In addition, monthly lease events may also be reported and collected during the term of the lease. Monthly lease events identify events such as on-time payments, late payments, late payments with late fees, late payments without late fees, damage reports (whether positive or negative), complaints, etc. In one embodiment, all monthly lease events are reported; however, in many situations, a landlord may wish to report only lease violations or aberrations in the tenant's behavior. In the latter case, the applications server can infer good behavior between events, allowing the applications server to develop a rich record of the tenant's least history.

In FIG. 2, the first lease history 208 for Jimmy Carter includes nine lease events: a lease commencement event 218, seven monthly lease events 220, and a lease termination event 222. In this lease history 208, the monthly lease events 220 were reported on a monthly basis. This circumstance is most common when monthly payment information is electronically communicated from a property management software application on a scheduled or somewhat automated basis.

The second lease history 210 for Jimmy Carter includes four lease events: a lease commencement event 224, two monthly lease events 226, and a least termination event 228. In this lease history 210, the monthly lease events 226 were not reported on a monthly basis; therefore the applications server infers on-time rent payments in the non-reported months. This circumstance is most common when monthly payment information requires some manual intervention. For example, a landlord may manually transmit (e.g., by email) monthly lease event data for a tenant when there is a problem (e.g., a late payment).

For the purpose of illustration, consider a circumstance wherein Jimmy Carter pays the rent late (e.g., events 226) and vacates under agreement with the landlord in the second lease history 210. The landlord transmits the lease termination event data to the central repository. In a third lease history 212, assume Jimmy Carter has recurring late payments and eventually skips on the lease with outstanding payments and considerable damage to the property. Under these conditions, a subsequent prospective landlord can receive Jimmy Carter's lease application, check Jimmy Carter's deteriorating rental performance and reject his lease application on these terms or require a larger deposit. In addition, on the basis of Jimmy Carter's lease application to subsequent prospective landlords, the landlord associated with the second lease history can automatically receive notification of Jimmy Carter's location to aid in collection of the payments owed to him. This process is called “Skip Tracing”.

In one embodiment, information from an applicant's new lease application (or executed lease) is automatically reported to any past landlord who reported a negative lease termination event. Automatic skip trace reporting may be limited to those landlords that are still subscribing to the skip trace service. Furthermore, in another embodiment, a landlord may request notification on skip traces for only a specified group of tenants, so as to limit the amount of reports received. In either embodiment, for example, a landlord can receiving information that can lead the landlord or a collection agency to the debtor tenant for collection purposes.

In contrast, Abraham Lincoln has lease histories that are relatively clean, with a possible late payment in the first month of the first least history 214 but excellent compliance thereafter. As such, a subsequent prospective landlord can receive Abraham Lincoln's lease application, check his improved rental performance and accept his lease application with some confidence in continued good performance.

One important aspect of the payment history system described herein is that multiple property managers may report data to a central repository, in which reporting from various property managers is combined in association with a given lease and a given consumer to provide a profile of the consumer's payment history. Furthermore, such information is accessible by other property managers who have or have not had experience with the consumer to assist in the negotiation or setting of agreement terms.

In an alternative embodiment, collections event data may also be reported and collected to the central repository. For example, if the landlord for Jimmy Carter's lease described by lease history 210 attempted to collect any outstanding payments from Jimmy Carter, then data relating to the collection activities may be reported as collections events. One exemplary collections event may be reporting of a payment schedule to fulfill the terms of the lease. Another exemplary collections event may be a payment concession by the landlord, thereby reducing the amount due from the lessee. Yet another exemplary collection event may be a bankruptcy proceeding by the lessee.

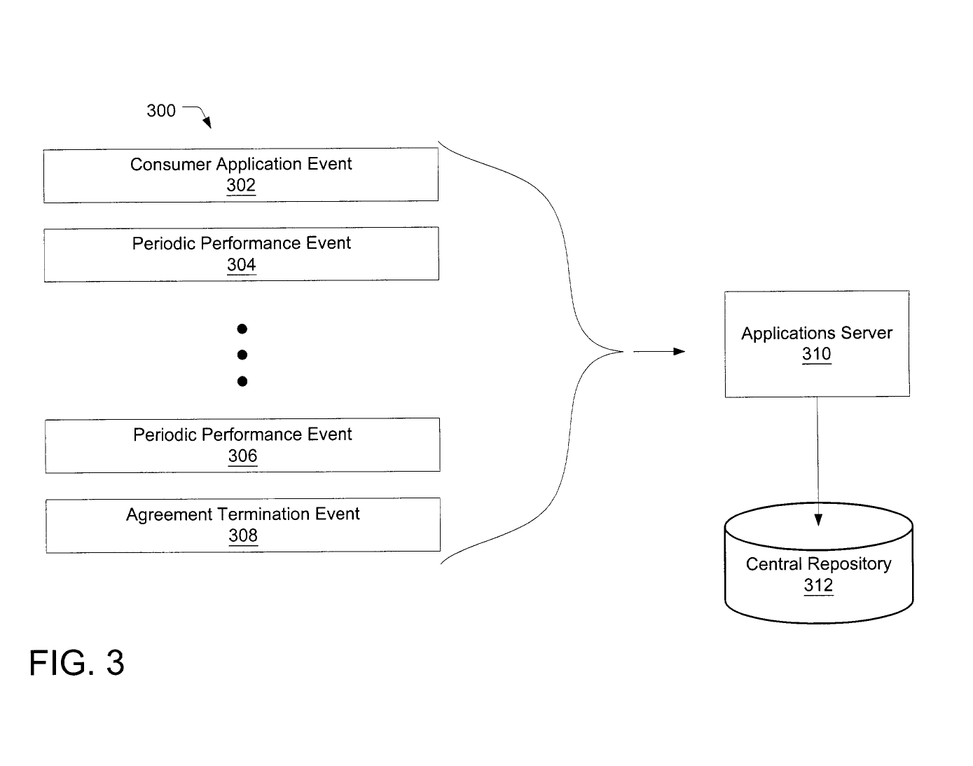

It should be understood that the embodiment shown in FIG. 2 is described as being related to leasing arrangement. However, a party's performance as to other types of agreements, such as subscriptions and memberships, may also be reported and collected in alternative embodiments. In a more general agreement-based vernacular, a “consumer lease record” may be termed a “consumer agreement record”, a “lease history” may be termed an “agreement history”, and a “lease event” may be termed an “agreement event”. Individual agreement events may be defined as discussed with regard to FIG. 3.

FIG. 3 illustrates an agreement history 300 in an embodiment of the present invention. An agreement history is a generic analog to a lease history. A consumer application event 302 (an analog to a lease commencement event) initiates the agreement history, such as by providing identifying information relating to the parties and the terms of the agreement. An agreement termination event 308 ends the agreement history 300 and captures information relating to the final resolution of the agreement (e.g., disputes, outstanding payments, incomplete performance, etc.). Periodic performance events 304 and 306 represent events occurring during the period of the agreement, such as violations, trigger points, amendments, and milestones.

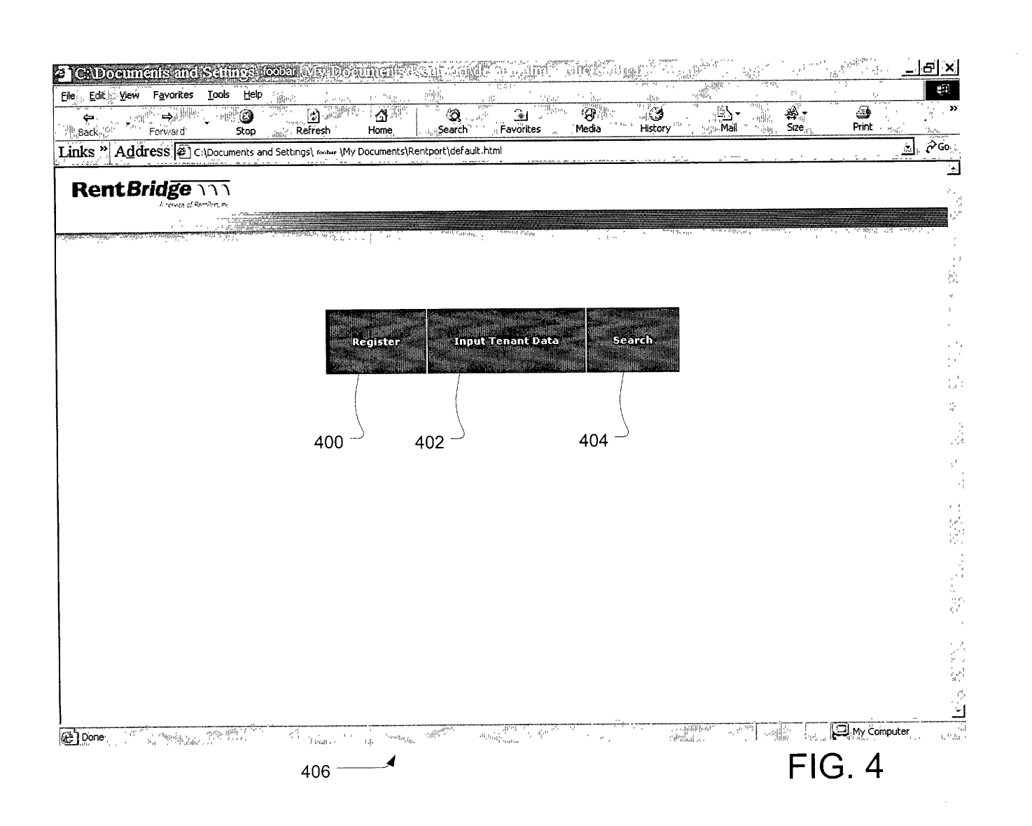

FIG. 4 illustrates an options screenshot from a payment history system in an embodiment of the present invention. The Options screenshot (and all of the exemplary screenshots derived herein) are in the form of a Web page. A user may select various controls and enter data into forms in the Web pages to input data and invoke operations. The options screen shot 406 offers three options: a Register option 300, an Input Tenant Data option 302, and a Search option 304. The Register option 300 may be selected to allow a user (e.g., a landlord) to register his property with the payment history system. The Input Tenant Data option 302 may be selected to allow the user to report data relating to a tenant. Typically, such data relates to a lease event. The Search option 304 may be selected to allow a user to search the central repository for information on a specified tenant.

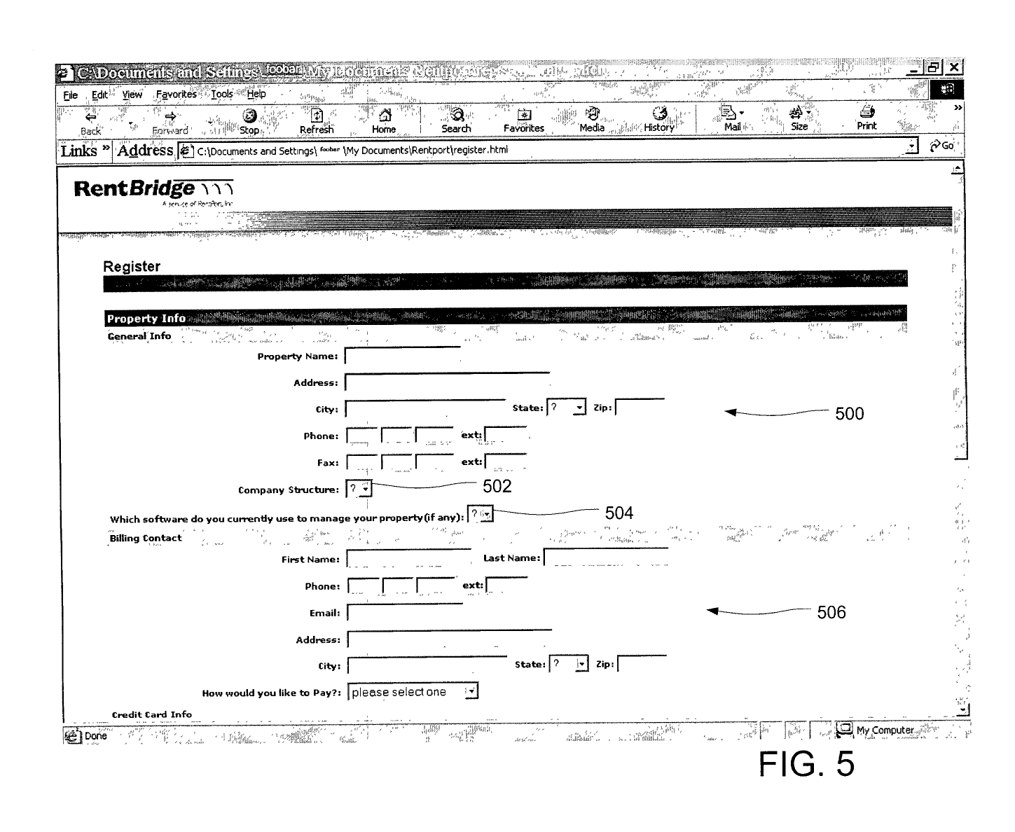

FIG. 5 illustrates a first portion of a registration screenshot from a payment history system in an embodiment of the present invention. To register a property with the payment history system, a user provides identifying information, billing information and contact information into the registration screen. A General Info section 500 accepts information identifying the property and contact information for the property itself. In addition, the General Info section 500 also include a Company Structure drop-down box 502 through which a user can select predefined options defining the structure of the property owner. Exemplary options may include individual owner, property management company, partnership, REIT (Real Estate Investment Trust), mobile home park operator, time-share management company, etc. Such options can be used to sort data in the central repository, which can increase the precision of managing and reporting the date for data recipients.

The General Info section 500 also includes a drop-down box 504 through which a user may select the property management software application he or she uses to manage the property. This information can be used to select an appropriate translation interface or communication for electronic communications with the property manager's software. In addition, it can be used by the data collection company to evaluate its customer needs and trends relative to property management software. A Billing Contact section 506 accepts information relating to the billing contact and the type of billing selected for access to the payment history system. Type of billing options may include invoicing, credit card payments, and pre-payments.

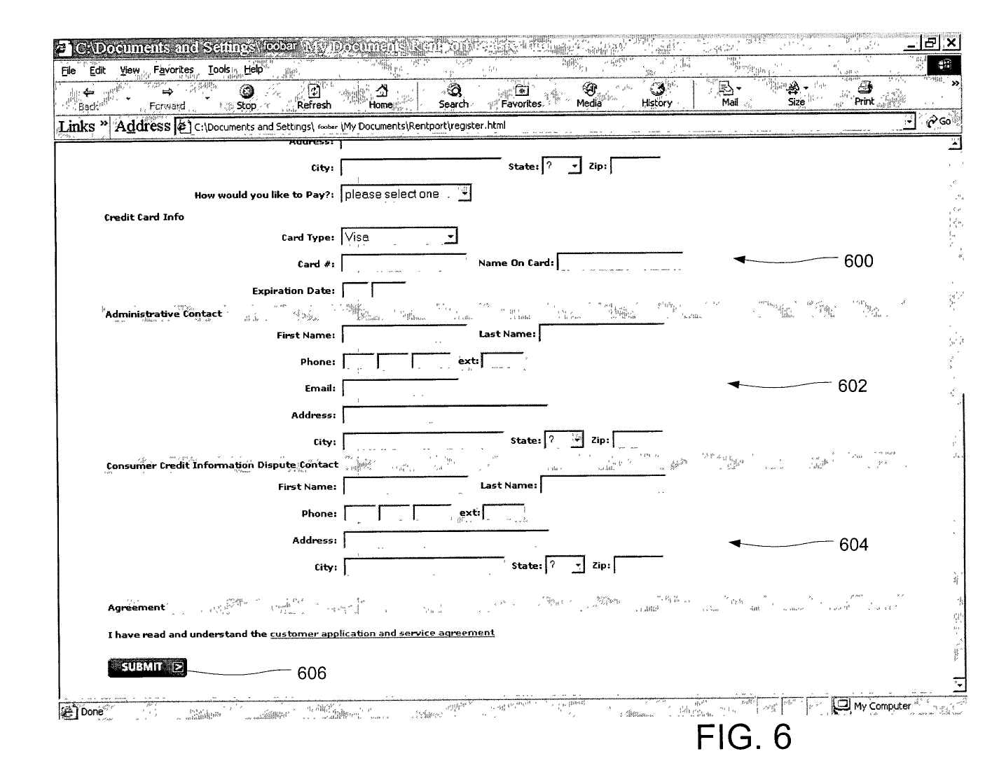

FIG. 6 illustrates a second portion of an introductory registration screenshot from a payment history system in an embodiment of the present invention. A Credit Card Info section 600 accepts information relating to the credit card payment option. An Administrative Contact section 602 accepts information relating to the individual responsible for administering the reporting process. This information is used to contact the landlord to provide support and to provide information about upgrade, system problems, and other aspects of the system and its use. A Consumer Credit Information Dispute Contact section 604 accepts information relating to consumer disputes (e.g., if the data collector receives a notice from a lessee that reported information is in error). The Consumer Credit Information Dispute Contact section 604 includes contact information for the dispute representative for the landlord. Negative lease events that are disputed may be marked on the lessee's rental history report, which may also provide details about the grounds for the dispute and its eventual resolution. Dispute data may be reported by a court, a bank (e.g., relating to an escrowed rent payment), or other dispute-related entities.

A Submit button 606 submits the information entered in the form to the applications server for registration. By registering, a customer (e.g., a landlord) receives a customer identifier and a password. A customer may also received service instructions, either on-line, via mail or email, or via a phone call from the data collector. In one embodiment, a service contract may be formed on the basis of registrations, although other embodiments may require execution of a hard copy agreement.

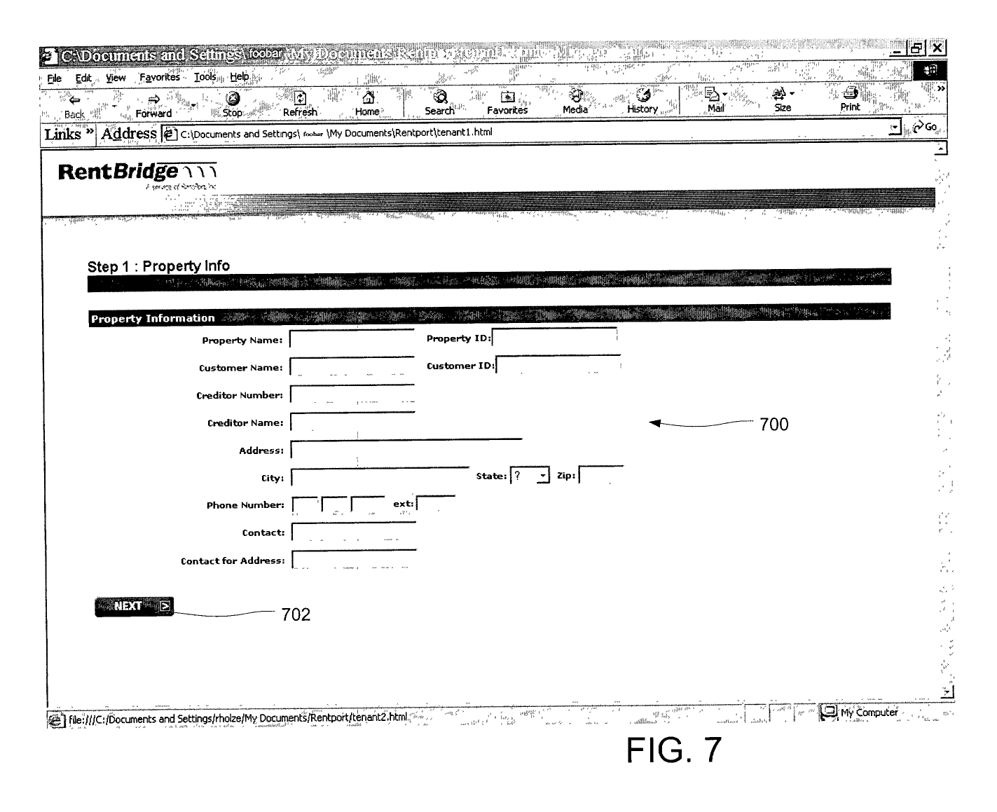

FIG. 7 illustrates a screenshot of a first stage in a tenant data input process from a payment history system in an embodiment of the present invention. A Property Information section 700 accepts information identifying the property. A Next button 702 may be selected to navigate the user to the next stage of the reporting operation.

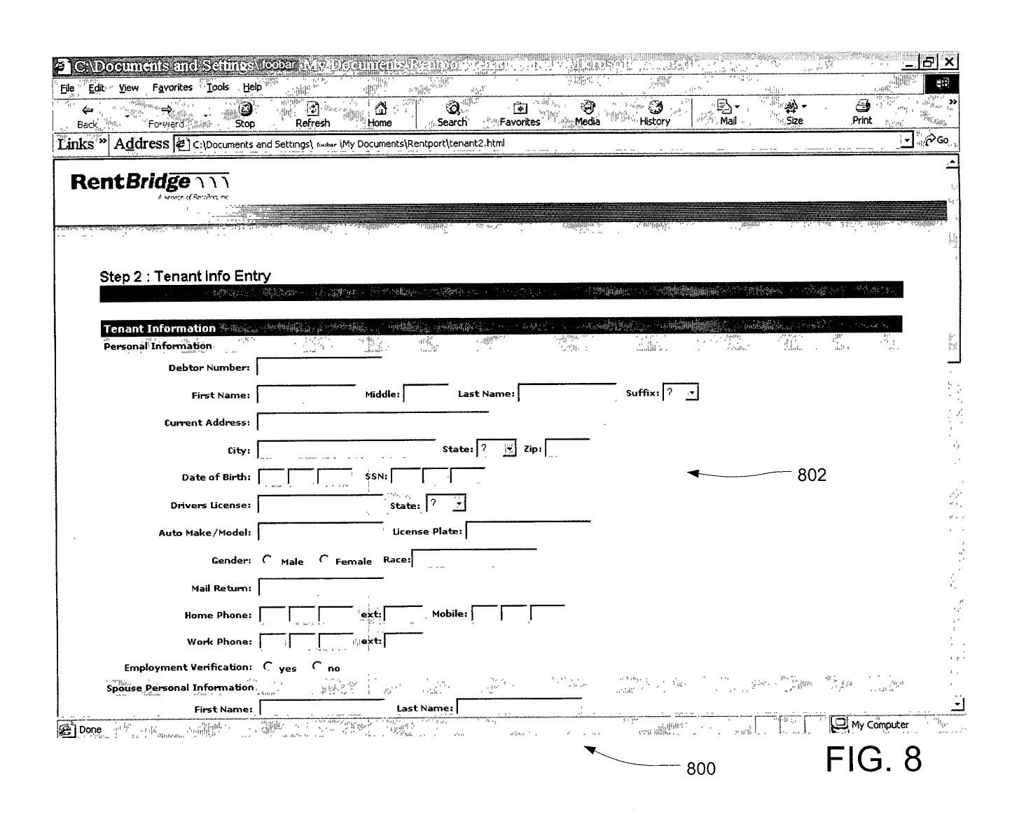

FIG. 8 illustrates a first portion of screenshot of a second stage in a tenant data input process from a payment history system in an embodiment of the present invention. This second stage allows reporting of lease application information and corresponds to an exemplary lease commencement event. A Tenant Info Entry screen 800 includes a Personal Information section 802 that accepts data describing the tenant. If the property has already been entered into the central repository, the Tenant Info Entry screen 800 may be auto-populated with the rest of the associated data after input of appropriate identification (e.g., property ID and/or customer ID).

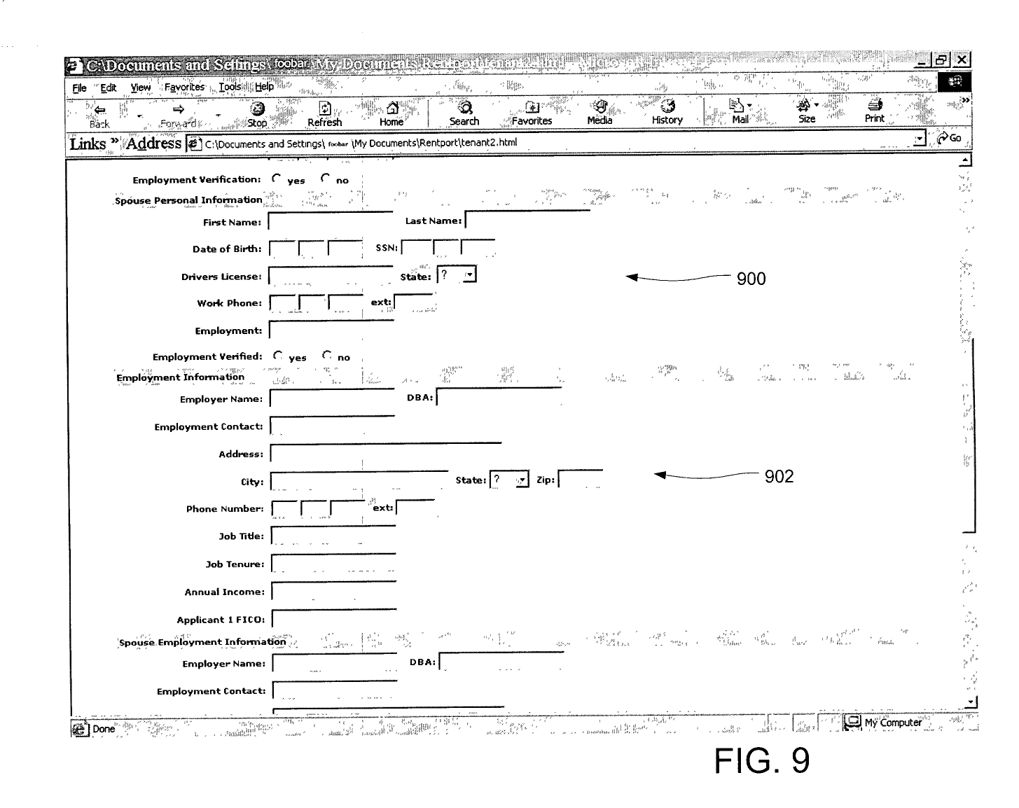

FIG. 9 illustrates a second portion of screenshot of a second stage in a tenant data input process from a payment history system in an embodiment of the present invention. A Spouse Personal Information section 900 accepts information describing the tenant's spouse, if the tenant has one. An Employment Information section 902 accepts information describing the tenant's employment. If the tenant has already been entered into the central repository, the screen for this stage may be auto-populated with the rest of the associated data after input of appropriate identification (e.g., debtor ID).

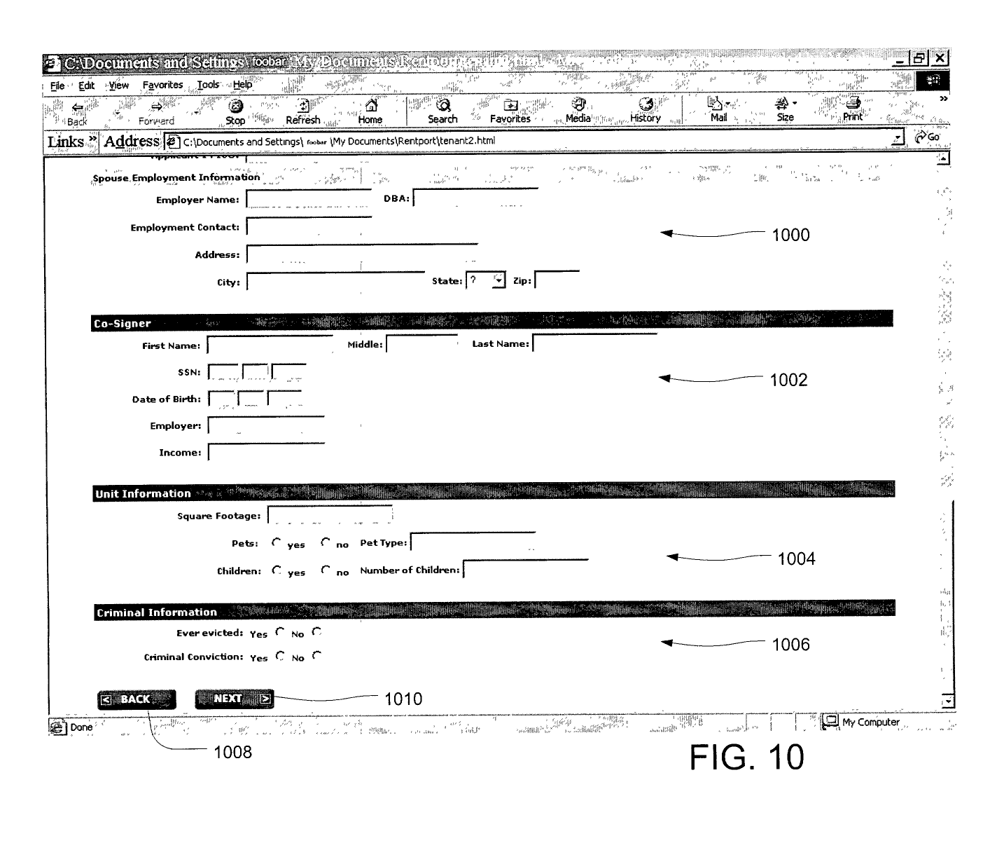

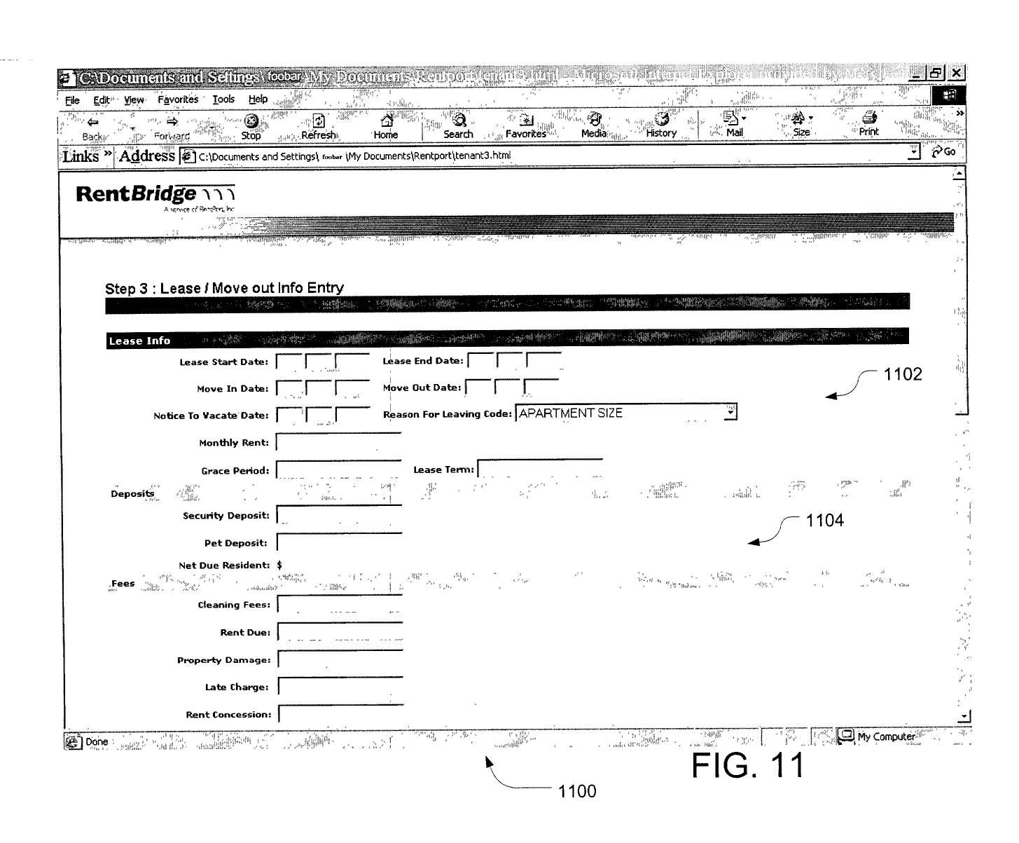

FIG. 10 illustrates a third portion of screenshot of a second stage in a tenant data input process from a payment history system in an embodiment of the present invention. A Spouse Information section 1000 accepts information describing the employment of the tenant's spouse, if the tenant has one. A Co-signer section 1002 accepts information describing the co-signer on the lease, if one exists. A Unit Information section 1004 accepts information describing the square footage of the unit leased by the tenant, whether the tenant has pets and what kind of pets, whether the tenant has children and how many children. A Criminal Information section 1006 accepts data describing any past criminal record the tenant may have. A Back button 1008 allows a user to navigate back to the Step 1—Property Info page shown in FIG. 7. The Next button 1010 allows a user to navigate to the Stage 3—Lease/Move Out Info Entry page shown in FIG. 11.

FIG. 11 illustrates a first portion of screenshot of a third stage in a tenant data input process from a payment history system in an embodiment of the present invention. This third stage allows reporting of information relating to monthly lease events and lease termination events. A Lease/Move Out Info Entry screen 1100 includes a Lease Info section 1102 that accepts data describing the lease. A Deposits section 1104 accepts data relating to security and pet deposits. The results displayed in the “net due” fields can be automatically calculated (e.g., deposit minus damage, outstanding rent, and unpaid utilities).

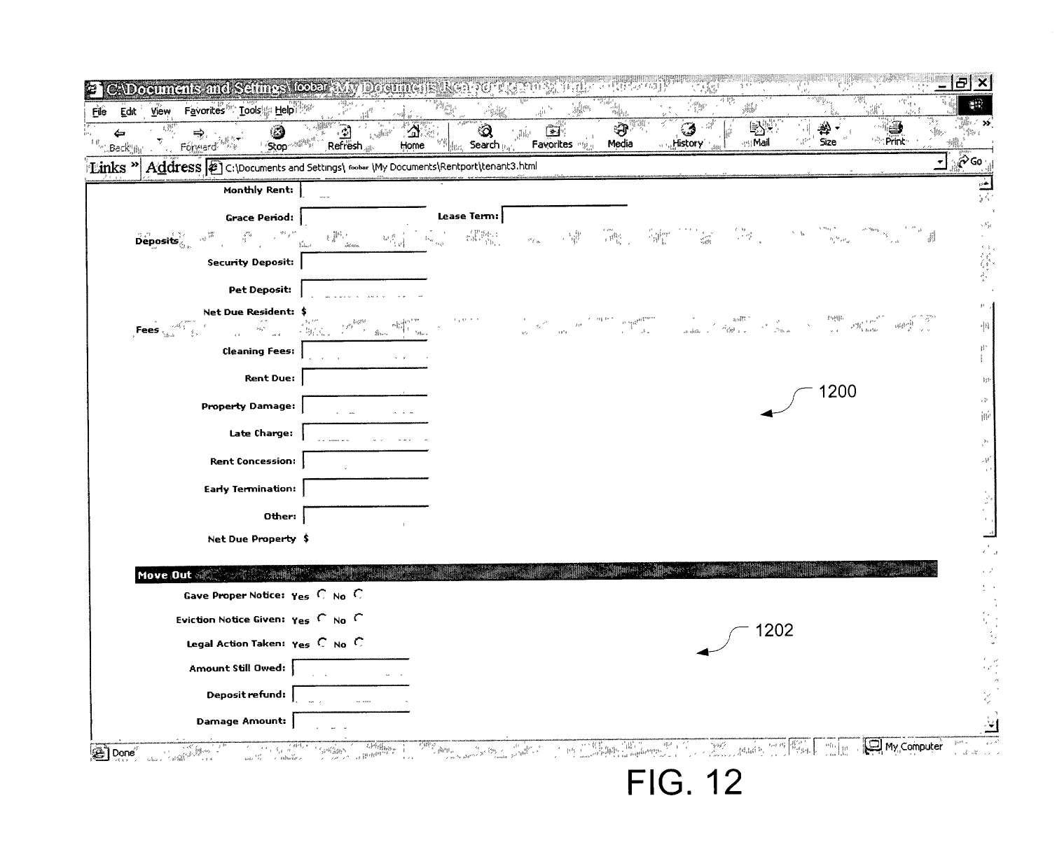

FIG. 12 illustrates a second portion of screenshot of a third stage in a tenant data input process from a payment history system in an embodiment of the present invention. A Fees section 1200 accepts information relating to fees owed by the tenant to the property manager. A Move Out section 1202 accepts data relating to conditions of the tenants vacating of the property. Such information helps subsequent prospective landlords evaluate the risks associated with renting to the tenant.

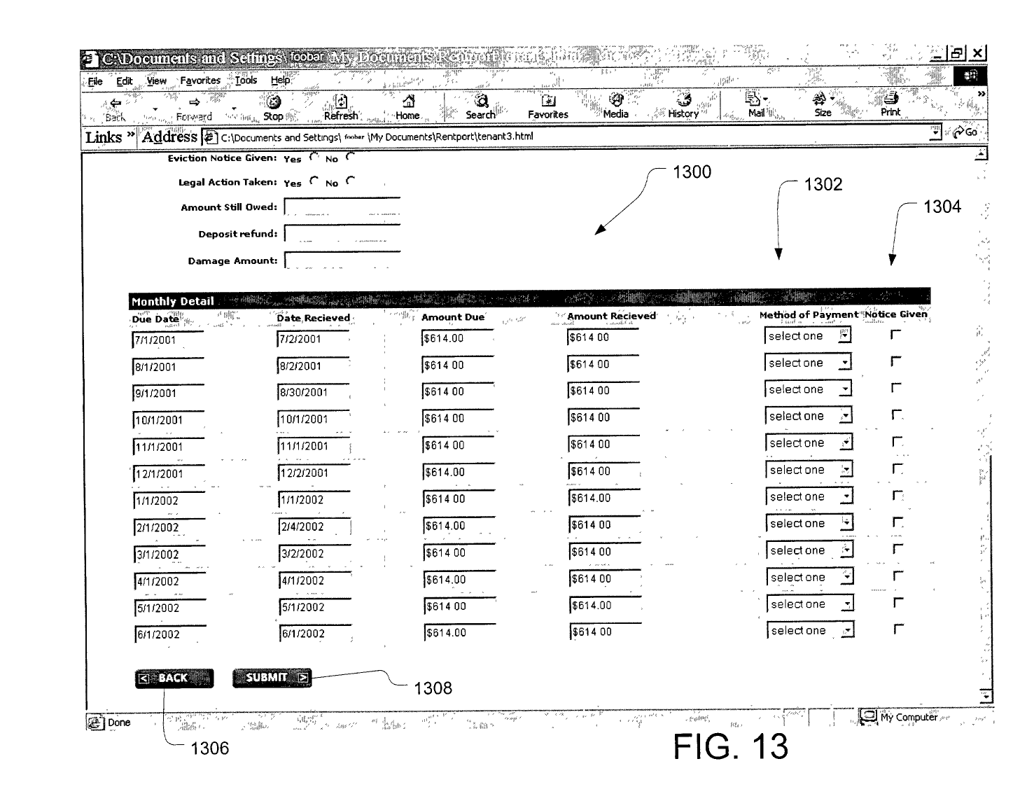

FIG. 13 illustrates a third portion of screenshot of a third stage in a tenant data input process from a payment history system in an embodiment of the present invention. A Monthly Detail section accepts data relating to monthly payments. From this information, it can be determined whether a payment is late or otherwise insufficient. Moreover, patterns or trends in payments can be detected. A column 1302 accepts information relating to the method of payment, such as cash, check, credit card, etc. Trends and patterns can also be detected from this information. For example, if a tenant who normally pays on-time in cash begins to pay late and then begins to pay late with a credit card, this may signal an increasing problem with future rent payments. A column 1304 accepts a selection relating to whether an eviction notice was given to the tenant in association of the payment due date.

In another embodiment, various form fields, if populated, can be annotated through an adjacent form field (not shown), which may be statically or dynamically displayed. For example, in association with the Property Damage field of section 1200 of FIG. 12, a form field may be displayed to allow input of an explanation of the damage (“Hole in master bedroom wall requiring repair”).

In yet another embodiment of the present invention, data relating to previous payments by the lessee under the current lease can be auto-populated in section 1300. For example, if the property manager is entering payments for December in the illustrated screen, rows for July through November would be populated with appropriate data, whereas rows for December through June would be blank (or zeroed out, or some similar indication that no data has yet been entered).

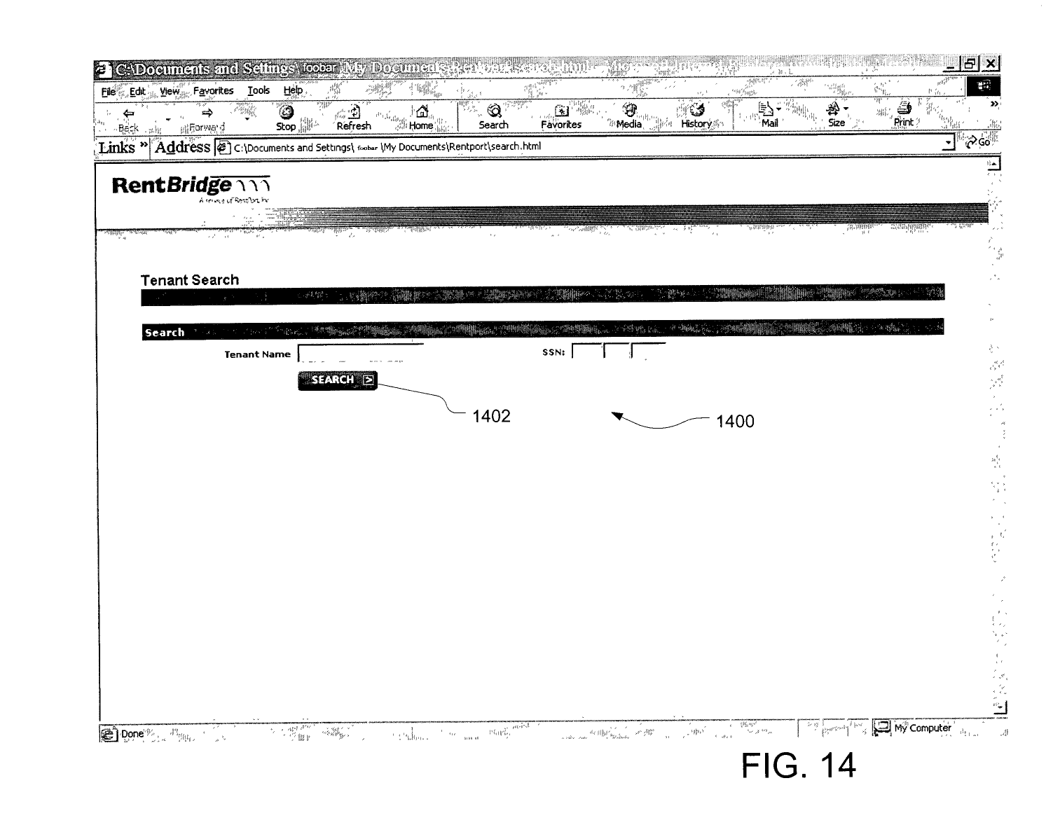

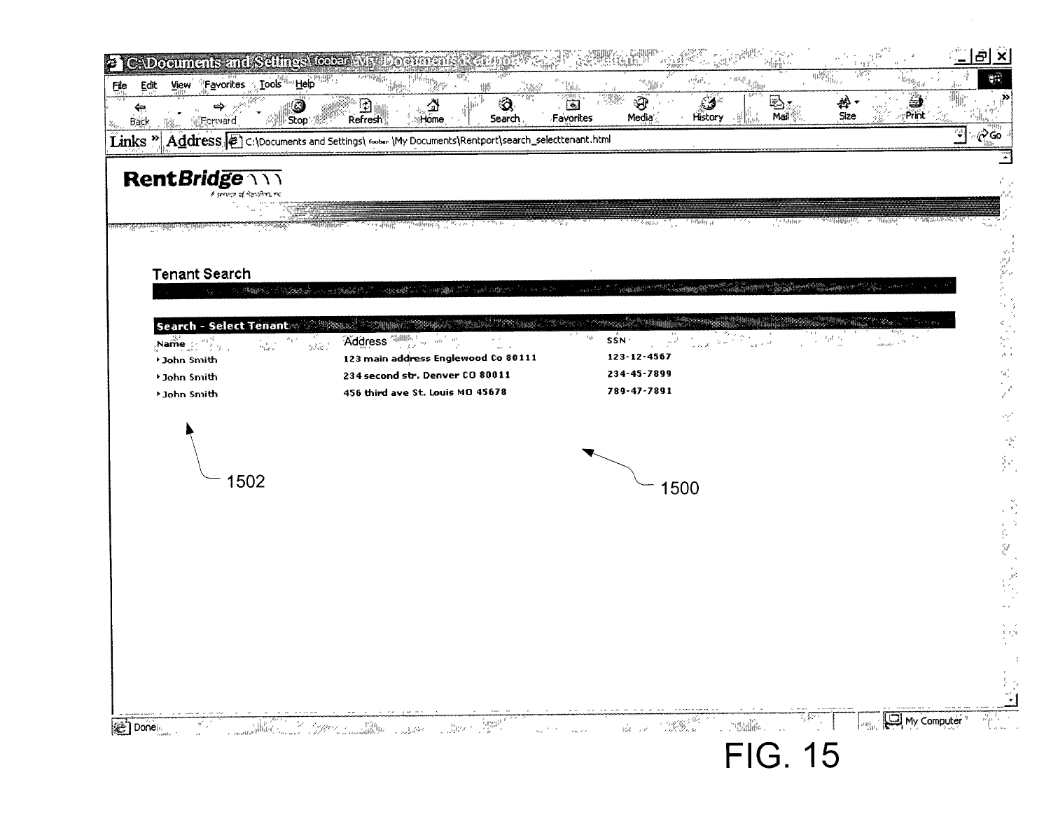

FIG. 14 illustrates a screenshot of a tenant search query form in an embodiment of the present invention. Search parameters relating to either or both of the tenant's name and social security number may be entered in Tenant Search section 1400. Tenant records in the central repository that satisfy the search parameter(s) are returned in a Tenant Search Results List, shown in FIG. 15. A Search button 1402 may be selected to invoke the search function.

FIG. 15 illustrates a screenshot of a tenant search results list from a payment history system in an embodiment of the present invention. A Tenant Search Results List 1500 displays search results satisfying the search parameter(s) entered in the Tenant Search section 1400 of FIG. 14. In the illustrated Tenant Search Results List 1500, results matching the name “John Smith” are returned with addresses and social security numbers. A user can then select individual names from the column 1502 to view Tenant Search Result information relating to the selected name.

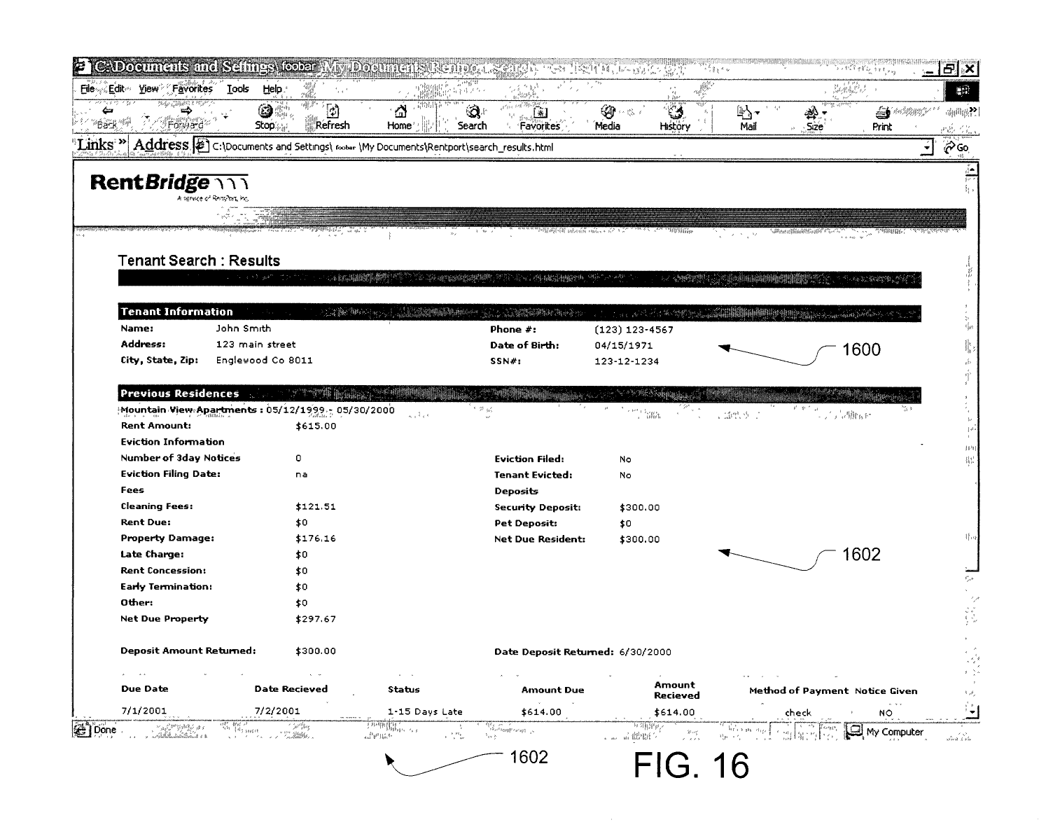

FIG. 16 illustrates a first portion of a screenshot of a tenant search result from a payment history system in an embodiment of the present invention. A Tenant Search Result page 1601 includes a Tenant Information section 1600 that displays information relating to the selected tenant. A Previous Residences section 1602 lists rent payment histories and other information relating to the selected tenant. If the tenant has reported rent payment histories for multiple leases or properties, that information is preferably displayed in sequence in the Tenant Search Result page 1601.

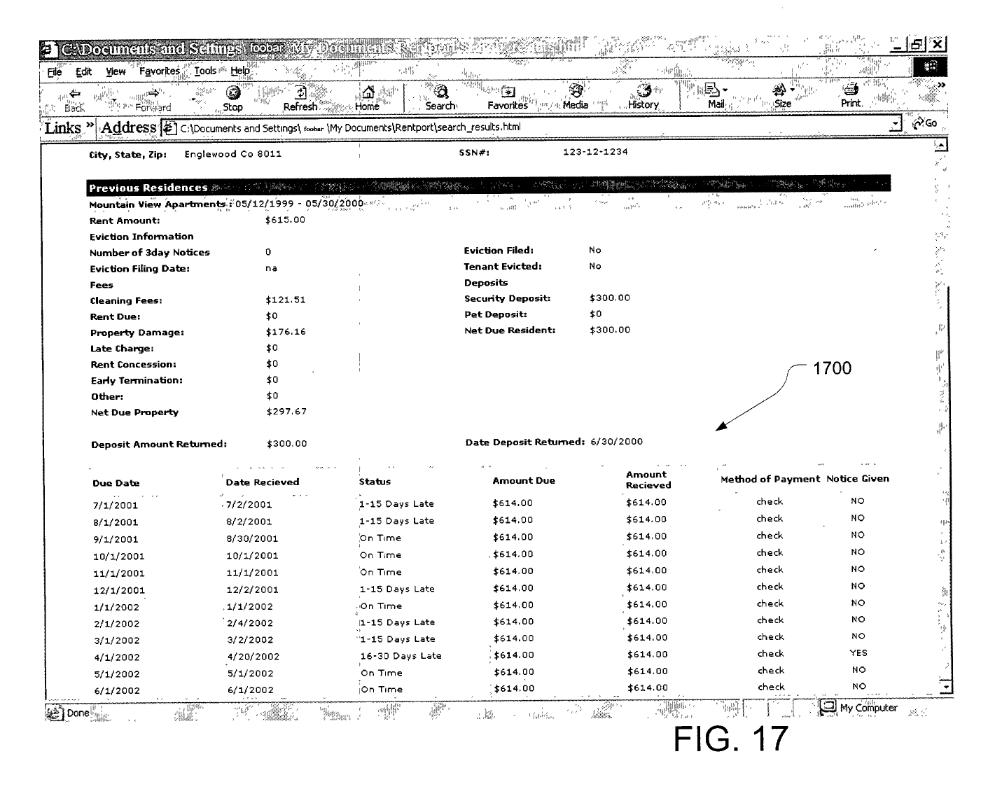

FIG. 17 illustrates a second portion of screenshot of a tenant search result from a payment history system in an embodiment of the present invention. A Monthly Information section 1700 displays detailed information relating to the monthly lease events during the term of the lease.

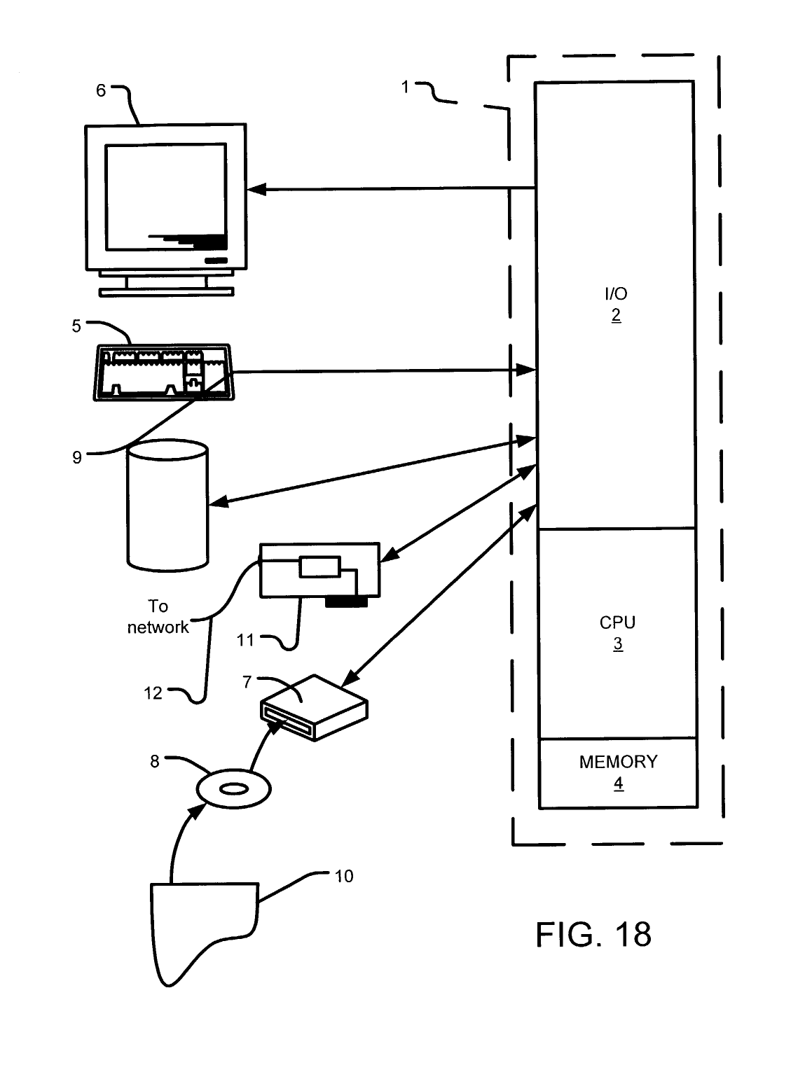

FIG. 18 illustrates an exemplary system useful for implementing an embodiment of the present invention. A general purpose computer is capable of executing a program product embodiment of the present invention. One operating environment in which the present invention is potentially useful encompasses the general purpose computer. In such a system, data and program files may be input to the computer, which reads the files and executes the programs therein. Some of the elements of a general purpose computer are shown in FIG. 18 wherein a processor 1 is shown having an input/output (I/O) section 2, a Central Processing Unit (CPU) 3, and a memory section 4. The present invention is optionally implemented in software devices loaded in memory 4 and/or stored on a configured CD-ROM 8 or storage unit 9 thereby transforming the computer system in FIG. 18 to a special purpose machine for implementing the present invention.

The I/O section 2 is connected to keyboard 5, display unit 6, disk storage unit 9, and disk drive unit 7. Generally, in contemporary systems, the disk drive unit 7 is a CD-ROM driver unit capable of reading the CD-ROM medium 8, which typically contains programs and data. Computer program products containing mechanisms to effectuate the systems and methods in accordance with the present invention may reside in the memory section 4, on a disk storage unit 9, or on the CD-ROM medium 8 of such a system. Alternatively, disk drive unit 7 may be replaced or supplemented by a floppy drive unit, a tape drive unit, or other storage medium drive unit. The network adapter 11 is capable of connecting the computer system to a network via the network link 12, through which the computer system can receive instructions and data embodied in a carrier wave. Examples of such systems include SPARC systems offered by Sun Microsystems, Inc., personal computers offered by IBM Corporation and by other manufacturers of IBM-compatible personal computers, and other systems running a UNIX-based or other operating system. In accordance with the present invention, software instructions such as those directed toward communicating between a client and a server, providing a user interface, and accessing data and services may be executed by CPU 3, and data such as polling schedules, point and meter data, and rates may be stored on disk storage unit 9, disk drive unit 7 or other storage medium units coupled to the system.

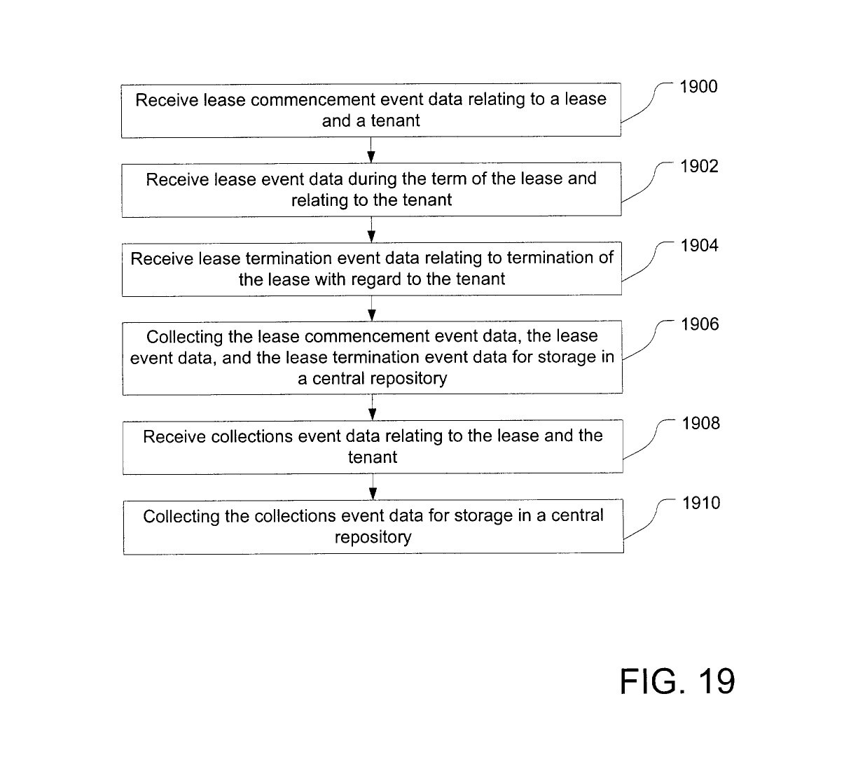

FIG. 19 illustrates operations for collecting one or more lease histories in an embodiment of the present invention. A receiving operation 1900 receives a lease commencement event data relating to the application for a lease or the start of a lease. In one embodiment, the property manager reports the information submitted by the lessee to the central repository. The information is associated with the lessee and a lease or a prospective lease for a property. Another receiving operation 1902 receives lease event data relating to lease events (e.g., a periodic payment, a missed payment, etc.) occurring during the term of the lease. Yet another receiving operation 1904 receives lease termination event data relating to termination of the lease. Such information may describe one or more end-of-lease closing circumstances, including without limitation the amount of money due to the property manager at the end of the lease, the amount of deposit returned to the lessee, the amount of damage done by the lessee to the property, outstanding utility bills, etc. A collection operation 1906 stores the received data into a central repository, where it can be accessed by authenticated customers, such as landlords and credit bureaus.

Another receiving operation 1908 receives collections event data relating to attempts to collect outstanding payments from the lessee. For example, if the lessee works out a payment arrangement with the landlord over time, the additional payments may be reported to the central repository, thereby repairing to some extent the negative impact the outstanding payments may have had on the lessee's credit rating. As such, the system provides an opportunity for a lessee to repair damage to his or her credit rating caused by a poor lease history in the past. A second collection operation 1910 stores the collections event data in the central repository, where it can be accessed by data recipients.

It should be understood that the collection operations 1906 and 1910 may be split into individual storing operations for each type of received data and even for individual event data. The individual storing operations may be temporally distributed in any order and may be intersperse among any number or type of receiving operation. As such, other embodiments (not shown) may order or group individual storing operations in a manner that is different than that shown by FIG. 19. Additional operations (not shown) to authenticate data recipients and to communicate the data to such recipients may also be implemented.

The embodiments of the invention described herein are implemented as logical steps in one or more computer systems. The logical operations of the present invention are implemented (1) as a sequence of processor-implemented steps executing in one or more computer systems and (2) as interconnected machine modules within one or more computer systems. The implementation is a matter of choice, dependent on the performance requirements of the computer system implementing the invention. Accordingly, the logical operations making up the embodiments of the invention described herein are referred to variously as operations, steps, objects, or modules.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A system for collecting one or more lease histories, each lease history relating to a lease of a property and a lessee of the property, the system comprising:
a lease commencement module receiving from a property manager lease application data relating to the first lease and the first lessee associated with a first property;
a periodic lease event module receiving from the property manager periodic data relating to one or more periodic payments of rent submitted during the term of the first lease by the first lessee;
a lease termination module receiving from the property manager lease termination data describing an end-of-lease closing circumstance; and
a collection module storing the lease application data, the periodic data, and the lease termination data in a central repository as a first lease history.

2. The system of claim 1 further comprising:
a collections reporting module receiving data relating to collections activity associated with the first lease and the first lessee; and
a storing module storing the data relating to the collections activity in a central repository as a portion of the first lease history.

3. The system of claim 1 wherein the lease application data, the periodic data, and the lease termination data are electronically communicated from one or more property management software applications operated by the one or more property managers.

4. The system of claim 1 wherein the collection module stores a second lease history relating to a second lease and the first lessee associated with a second property in the central repository.

5. The system of claim 4 wherein the first and second lease histories constitute a consumer lease record associated with the first lessee.

6. The system of claim 4 wherein the lease application data, the periodic data, and the lease termination data associated with the first lease history is supplied by a different property manager than the lease application data, the periodic data, and the lease termination data associated with the second lease history.

7. The system of claim 1 wherein the collection module stores a second lease history relating to a second lease and a second lessee associated with a second property in the central repository.

8. The system of claim 7 wherein the lease application data, the periodic data, and the lease termination data associated with the first lease history is supplied by a different property manager than the lease application data, the periodic data, and the lease termination data associated with the second lease history.

9. The system of claim 1 wherein the property lease application data relates to a lease commencement event under the first lease associated with the first lessee.

10. The system of claim 1 wherein the periodic payment data relates to a periodic payment event under the first lease associated with the first lessee.

11. The system of claim 1 wherein the lease termination data relates to a lease termination event under the first lease associated with the first lessee.

12. The system of claim 1 further comprising an inference module inferring on-time payment of rent when periodic payment data is not reported in a cycle of a periodic schedule.

13. The system of claim 1 wherein the end-of-lease closing circumstance relates to a failure of the first lessee to pay a utility bill.

14. The system of claim 1 wherein the end-of-lease closing circumstance relates to a skip by the first lessee.

15. The system of claim 1 wherein the end-of-lease closing circumstance relates to an eviction of the first lessee.

16. The system of claim 1 wherein the end-of-lease closing circumstance relates to a paid-in-full lease termination associated with the first lessee.

17. The system of claim 1 wherein the lease termination data indicates a total amount due to the property manager at lease termination.

18. The system of claim 17 wherein the lease termination data details a plurality of monetary amounts contributing to the total amount due to the property manager at lease termination.

19. The system of claim 1 wherein the lease termination data indicates a total amount due to the lessee at lease termination.

20. The system of claim 19 wherein the lease termination data details a plurality of monetary amounts contributing to the total amount due to the lessee at lease termination.

21. A method of collecting one or more lease histories, each lease history relating to a lease of a property and a lessee of the property, the method comprising:
receiving from a property manager lease application data relating to the first lease and the first lessee associated with a first property;
receiving from the property manager periodic data relating to one or more periodic payments of rent submitted during the term of the first lease by the first lessee;
receiving from the property manager lease termination data an describing end-of-lease closing circumstance; and
storing the lease application data, the periodic data, and the lease termination data in a central repository as a first lease history.

22. The method of claim 21 further comprising:
receiving data relating to collections activity associated with the first lease and the first lessee; and
storing the data relating to the collections activity in a central repository as a portion of the first lease history.

23. The method of claim 21 further comprising:
electronically communicated the lease application data, the periodic data, and the lease termination data from one or more property management software applications operated by the one or more property managers.

24. The method of claim 21 further comprising:
storing a second lease history relating to a second lease and the first lessee associated with a second property in the central repository.

25. The method of claim 24 wherein the first and second lease histories constitute a consumer lease record associated with the first lessee.

26. The method of claim 24 further comprising:
receiving lease application data, periodic data, and lease termination data associated with the second lease history from a different property manager than the lease application data, the periodic data, and the lease termination data associated with the first lease history.

27. The method of claim 21 further comprising:
storing a second lease history relating to a second lease and a second lessee associated with a second property in the central repository.

28. The method of claim 27 further comprising:
receiving lease application data, periodic data, and lease termination data associated with the second lease history from a different property manager than the lease application data, the periodic data, and the lease termination data associated with the first lease history.

29. The method of claim 21 wherein the property lease application data relates to a lease commencement event under the first lease associated with the first lessee.

30. The method of claim 21 wherein the periodic payment data relates to a periodic payment event under the first lease associated with the first lessee.

31. The method of claim 21 wherein the lease termination data relates to a lease termination event under the first lease associated with the first lessee.

32. The method of claim 21 further comprising:
inferring on-time payment of rent when periodic payment data is not reported in a cycle of a periodic schedule.

33. The method of claim 21 wherein the end-of-lease closing circumstance relates to a failure of the first lessee to pay a utility bill.

34. The method of claim 21 wherein the end-of-lease closing circumstance relates to a skip by the first lessee.

35. The method of claim 21 wherein the end-of-lease closing circumstance relates to an eviction of the first lessee.

36. The method of claim 21 wherein the end-of-lease closing circumstance relates to a paid-in-full lease termination associated with the first lessee.

37. The method of claim 21 wherein the lease termination data indicates a total amount due to the property manager at lease termination.

38. The method of claim 37 wherein the lease termination data details a plurality of monetary amounts contributing to the total amount due to the property manager at lease termination.

39. The method of claim 21 wherein the lease termination data indicates a total amount due to the lessee at lease termination.

40. The method of claim 39 wherein the lease termination data details a plurality of monetary amounts contributing to the total amount due to the lessee at lease termination.

41. A computer program product encoding a computer program for executing on a computer system a computer process for collecting one or more lease histories, each lease history relating to a lease of a property and a lessee of the property, the computer program product comprising:
receiving from a property manager lease application data relating to the first lease and the first lessee associated with a first property;
receiving from the property manager periodic data relating to one or more periodic payments of rent submitted during the term of the first lease by the first lessee;
receiving from the property manager lease termination data describing an end-of-lease closing circumstance; and
storing the lease application data, the periodic data, and the lease termination data in a central repository as a first lease history.

42. The computer program product of claim 41 wherein the computer process further comprises:
receiving data relating to collections activity associated with the first lease and the first lessee; and
storing the data relating to the collections activity in a central repository as a portion of the first lease history.

43. The computer program product of claim 41 wherein the computer process further comprises:
electronically communicated the lease application data, the periodic data, and the lease termination data from one or more property management software applications operated by the one or more property managers.

44. The computer program product of claim 41 wherein the computer process further comprises:
storing a second lease history relating to a second lease and the first lessee associated with a second property in the central repository.

45. The computer program product of claim 44 wherein the first and second lease histories constitute a consumer lease record associated with the first lessee.

46. The computer program product of claim 44 further comprising:
receiving lease application data, periodic data, and lease termination data associated with the second lease history from a different property manager than the lease application data, the periodic data, and the lease termination data associated with the first lease history.

47. The computer program product of claim 41 wherein the computer process further comprises:
storing a second lease history relating to a second lease and a second lessee associated with a second property in the central repository.

48. The computer program product of claim 47 wherein the computer process further comprises:
receiving lease application data, periodic data, and lease termination data associated with the second lease history from a different property manager than the lease application data, the periodic data, and the lease termination data associated with the first lease history.

49. The computer program product of claim 41 wherein the property lease application data relates to a lease commencement event under the first lease associated with the first lessee.

50. The computer program product of claim 41 wherein the periodic payment data relates to a periodic payment event under the first lease associated with the first lessee.

51. The computer program product of claim 41 wherein the lease termination data relates to a lease termination event under the first lease associated with the first lessee.

52. The computer program product of claim 41 wherein the computer process further comprises:
inferring on-time payment of rent when periodic payment data is not reported in a cycle of a periodic schedule.

53. The computer program product of claim 41 wherein the end-of-lease closing circumstance relates to a failure of the first lessee to pay a utility bill.

54. The computer program product of claim 41 wherein the end-of-lease closing circumstance relates to a skip by the first lessee.

55. The computer program product of claim 41 wherein the end-of-lease closing circumstance relates to an eviction of the first lessee.

56. The computer program product of claim 21 wherein the end-of-lease closing circumstance relates to a paid-in-full lease termination associated with the first lessee.

57. The computer program product of claim 41 wherein the lease termination data indicates a total amount due to the property manager at lease termination.

58. The computer program product of claim 57 wherein the lease termination data details a plurality of monetary amounts contributing to the total amount due to the property manager at lease termination.

59. The computer program product of claim 41 wherein the lease termination data indicates a total amount due to the lessee at lease termination.

60. The computer program product of claim 59 wherein the lease termination data details a plurality of monetary amounts contributing to the total amount due to the lessee at lease termination.
